(19) United States
(12) Patent Application Publication
(10) Pub. No.: US 2007/0045398 A1
(43) Pub. Date: Mar. 1, 2007

(54) Credit card verification system

(76) Inventor: Han-ping Chen, Saratoga, CA (US)

Correspondence Address: Han-ping Chen, P.O. Box 2871, Saratoga, CA, 95070, US

(21) Appl. No.: 11/208,715

(22) Filed: Aug. 23, 2005

(51) Int. Cl. G06K 5/00

(52) U.S. Cl. 235/380

(57) ABSTRACT

A method and system verifies the validity of a credit card payment transaction with a set of requester account data by searching an account record database for a matched record containing a record account number that matches the requester account number and an expected verification key that matches the requester verification key, said expected verification key changes after each successful payment transaction validation, according to a pre-determined list of values, and a set of pre-determined rules, to enhance the security and robustness of account transactions. Also, the present invention provides a method and system that is cost-effective to implement and highly compatible with the current account verification procedure.

### BACKGROUND OF THE INVENTION

This invention relates to bank card, credit card, debit card, cash card, and other account verification devices.

Consumers often use credit cards and debit cards to purchase merchandises at point-of-sale locations, via public telephones, or over the Internet.

During a purchasing process, certain personal data are released, although in a limited way. Especially for payment transactions through telephones or over the Internet, the security of personal information is at risk.

Even when not conducting transactions, personal data may also fall into wrong hands due to improper placement or disposition of documents. These factors may lead to unauthorized uses of bank cards. This situation is sometimes referred to as identity theft.

To enhance the security of bank cards, issuing institutions assign card verification codes (CVC) and personal identification numbers (PIN) to bank card accounts.

To implement the security, a seller needs to ask the purchaser to present either a CVC or a PIN to verify the validity.

In a way, this still constitutes a release of personal bank card information. It is only secure if all the parties involved in the transaction are trustable.

For e-commerce transactions over the Internet, certain purchasers, because of unfamiliarity with the procedure or due to lack of patience, may issue an incorrect forward or backward command that causes a payment transaction to be processed more than once. This constitutes another potential problem for payment transaction processing.

### BRIEF SUMMARY OF THE INVENTION

This invention proposes a method and system to enhance the security and robustness of bank card transactions.

This invention provides a method and system to prevent unauthorized usage of bank cards due to release of personal information during payment transaction processing or misplacement of documents.

This invention provides a method and system for a purchaser to deliver a card verification code (CVC) or a personal identification number (PIN) to a seller without compromising the security of subsequent usage.

This invention proposes a method which is cost-effective and highly compatible with the current verification procedure.

This invention further proposes a method which offers flexibility and tolerance for certain special handling procedures used by some merchants when processing credit card transactions.

This invention further provides a method to prevent a transaction from being unintentionally processed more than once.

### BRIEF DESCRIPTION OF THE DRAWINGS

FIG. 1 is a diagram of a prior art bank card verification process.

FIG. 2 shows a prior art bank card data structure.

FIG. 3 shows a preferred embodiment of the present invention for a bank card data structure.

FIG. 4 shows a preferred embodiment of the present invention for a bank card verification process.

FIG. 5 shows another preferred embodiment of the present invention for a bank card verification process.

FIG. 6 shows a number of preferred embodiments of the present invention for a card holder to carry a list of verification keys.

FIG. 7 shows a preferred embodiment of the present invention for a key storage device.

FIG. 8 shows another preferred embodiment of the present invention for a key storage device.

FIG. 9 shows a preferred embodiment of the present invention for a key maintenance device.

### DETAILED DESCRIPTION OF THE INVENTION

The present invention will be illustrated with some preferred embodiments.

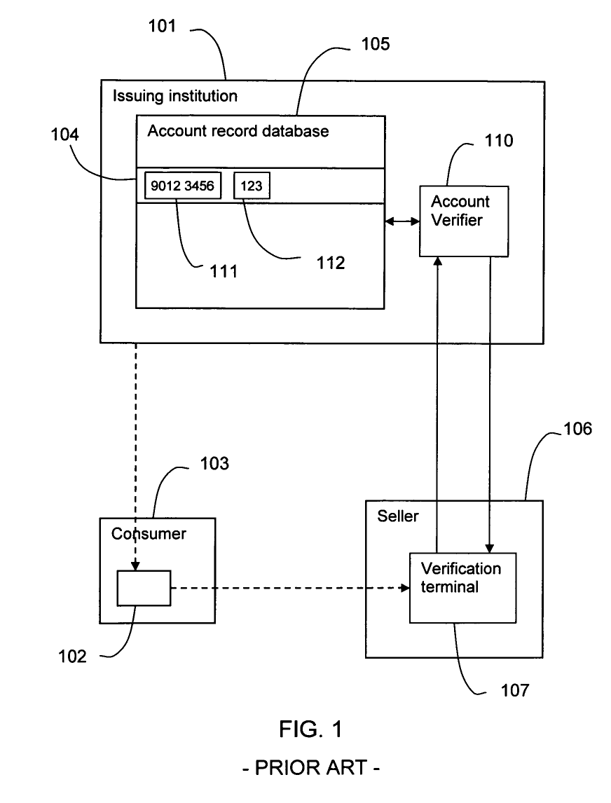

FIG. 1 shows a prior art bank card verification process. Initially, an issuing institution 101 issues a bank card 102 to a consumer 103. The bank card 102 contains a set of bank card data, such as a card number, a consumer name, an expiry date, and a card verification code. The issuing institution 101 keeps a consumer account record 104 in the account record database 105. A consumer account record 104 contains an account number 111 and a card verification code 112. It may also contain other account data such as an expiry date, a maximum limit amount, the current balance, the current status, the consumer name, the consumer address, previous transactions, and other reference data.

To make a purchase, the consumer 103 provides the seller 106 with the bank card data. The seller 106 transfers the bank card data through a verification terminal 107 to an account verifier 110 at the issuing institution 101 for verification. The seller 106 may also transfer the seller identification and the purchase amount together with the bank card data.

The account verifier 110 at the issuing institution 101 verifies the validity of received bank card data by searching the account record database 105 for a matched consumer account record 104 which matches the received bank card number. If a matched record is found, the account verifier 110 verifies other account data for consistency and limitations. The issuing institution 101 then sends the verification results to the seller 106.

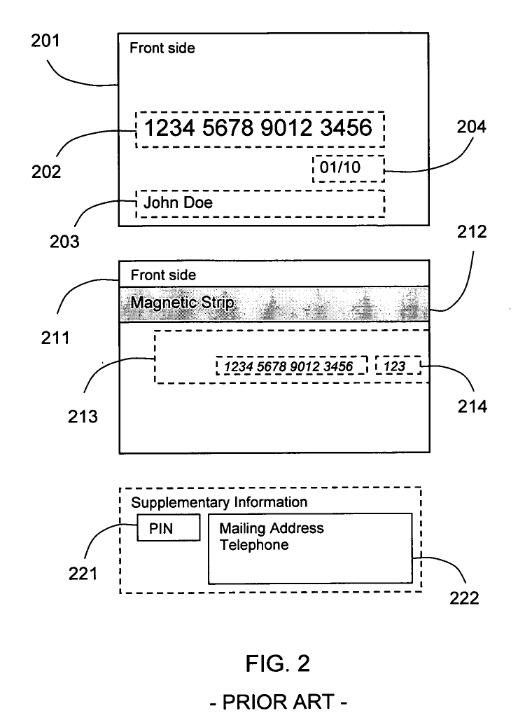

FIG. 2 shows a prior art bank card data structure. The front side 201 of the bank card contains a card number 202, a consumer name 203, and an expiry data 204.

The back side 211 of bank card contains a magnetic stripe 212 and a signature area 213. It also contains a card verification code (CVC) 214. Items 202, 203, 204, and 214 may be classified as the primary bank card data.

Associating with a bank card, a consumer also maintains supplementary information which includes a personal identification number (PIN) 221 and other personal data 222 such as a mailing address and a telephone number. Items 221 and 222 may be classified as the secondary bank card data.

Besides verifying the primary bank card data, some sellers also verify the secondary bank card data.

For a consumer bank card, the card verification code (CVC) 214 is normally a 3-digit or 4-digit fixed numeric code. The personal identification number (PIN) 221 is also a fixed number, normally with 4 to 6 digits.

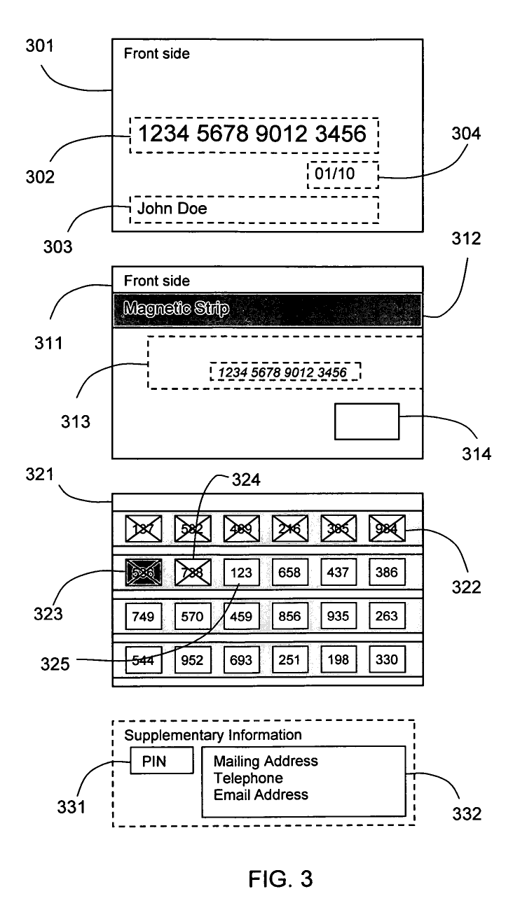

FIG. 3 shows a preferred embodiment of a bank card data structure. The front side 301 of the bank card contains a card number 302, a consumer name magnetic stripe 312 and a signature area 313. There is also an empty space 314 available to write in a verification key or attach a verification key label.

In addition, there is a companion verification key (VK) chart 321 supplied by the issuing institution.

The verification key chart 321 may be viewed as a list of verification keys (VK) such as 322, 323, 324, and 325. For each purchase transaction, the consumer selects a verification key from the chart 321 to use as a card verification code (CVC).

A verification key (VK) functions like a card verification code (CVC). However, instead of being a fixed number, a verification key is a variable number, which is different for each individual purchase transaction.

Associating with a bank card, a consumer also maintains supplementary information which includes a personal identification number (PIN) 331 and other personal data 332 such as a mailing address, a telephone number, and an email address.

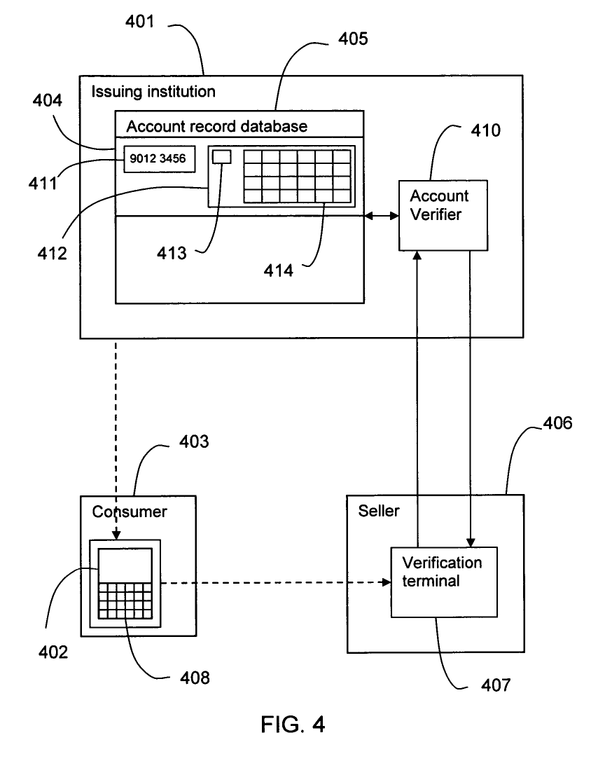

FIG. 4 shows a preferred embodiment of the present invention for a bank card verification process.

An issuing institution 401 issues a bank card 402 and a verification key chart 408 to a consumer 403. The data structure of the bank card 402 and the verification key chart 408 is as illustrated in FIG. 3.

The issuing institution 401 keeps a consumer account record 404 in the account record database 405. A consumer account record 404 contains an account number 411 and a verification key descriptor 412. It may also contain other account data such as an expiry date, a maximum limit amount, the current balance, the current status, the consumer name, the consumer address, previous transactions, and other reference data.

The verification key descriptor 412 contains a verification key table 414 and a key table index 413. The verification key table 414 contains a list of verification key entries. The key table index 413 points to an expected verification key entry in the verification key table 414.

To make a purchase, the consumer 403 selects the current verification key from the verification key chart 408, as illustrated in FIG. 3. The current verification key is used as a card verification code.

The consumer 403 provides the seller 406 with the bank card data, including the selected card verification code.

The seller 406 transfers the bank card data through a verification terminal 407 to an account verifier 410 at the issuing institution 401 for verification. The seller 406 may also transfer the seller identification and the purchase amount together with the bank card data.

The account verifier 410 at the issuing institution 401 verifies the validity of received bank card data by searching the account record database 405 for a matched consumer account record 404 which matches the received bank card number. If a matched record is found, the account verifier 410 verifies the received card verification code with the expected verification key, indexed by the key table index 413, in the verification key table 414.

The account verifier 410 may also verify other account data for consistency and limitations. The issuing institution 401 then sends the verification results to the seller 406.

If the transaction is successfully validated, the account verifier 410 modifies the key table index 413 to point to the next expected verification key in the verification key table 414.

The verification key table 414 contains a limited number of key entries. To operate the verification process on a continuous basis, a strategy is needed to either cycle through the key entries, or to update the key table contents as needed.

For illustration purpose, the account verifier 410 may use a cycle-through policy. If the current key table index is the last key entry in the key table, after a successful transaction validation, the account verifier 410 resets the key table index to point to the first key entry.

To use a table-updating policy, the account verifier 410 also needs to update the contents of the table with the next group of key entries.

On the card holder side, after each successful payment transaction validation, the card holder marks off the current verification key value that has just been used on the verification key chart. The next verification key value now appears to be a current verification key value on the chart.

Most merchants, when receives the credit card information from a card holder, sends the credit card information to a verification institution for verification immediately.

However, some merchants may defer the verification process of a payment transaction until a later time. Examples include hotels that defer credit card processing until check-out time, and rental car companies that defer credit card processing until car return time.

To strictly ensure the security, a verification system may choose not to allow deferred processing.

To allow more flexibility, a verification system may allow a number of verification keys, associated with deferred payment transactions, to be skipped. It will accept the next following verification key as a valid verification key.

We may use the verification key chart 321 in FIG. 3 as an example to illustrate the verification procedure. The verification key chart 321 contains a list of verification keys (VK).

A card holder uses verification key 322 in a first payment transaction. The verification key 322 is sent by a first merchant to the verification system to be processed immediately.

Afterwards, the card holder uses verification key 323 in a second payment transaction. A second merchant defers the verification process. It does not send verification key 323 to the verification system to be processed immediately.

The card holder subsequently uses verification key 324 in a third payment transaction. This time, a third merchant sends verification key 324 to a verification system to be processed immediately.

At this point, the verification system normally expects to receive verification key 323. To provide additional flexibility, the verification system also considers verification key 324 to be an acceptable verification key, assuming that verification key 323 has been deferred by a merchant.

At a later time, the second merchant sends the deferred verification key 323 for verification. At this time, the verification system normally expects to receive verification key 325. It will also consider the deferred verification key 323 to be an acceptable verification key, as long as the deferred length of time is within a pre-defined reasonable time limit.

There are also some merchants that perform credit card transaction verification without a card verification code. To strictly ensure the security, a verification system may choose not to accept any transactions without a card verification code.

However, some merchants using a non-code verification method may be highly trustable by the issuing institution. They may also have special agreements with the issuing institution.

Some of the merchants have other customer information to prove the payment transaction. They may also take the risk themselves, in order to simplify the verification procedure. Examples include parking lots and self-service gas stations.

A verification system may choose to accept non-code transactions from pre-qualified trustable merchants. In such cases, a variable-code verification procedure needs to co-exist with a non-code verification procedure.

A verification system may also allow a card holder, under certain environments, to use a pre-determined fixed verification key to conduct payment transactions. This verification mode is essentially the same as a prior art credit card verification method.

In summary, a verification system may allow the following verification modes: a variable-key verification mode, a fixed-key verification mode, and a non-key verification mode.

To further enhance the security of payment transaction, a verification system may use a verification key that contains information about the payment transaction. Payment transaction information may include payment amount, payment date, or merchant identification. In this case, the verification system needs to receive the payment transaction information from the requester, along with the verification key to perform the validation.

Since a verification key may be just a 3-digit number, it may not contain an actual payment amount. The verification key may only contain a combined signature of the current key code and the current payment amount.

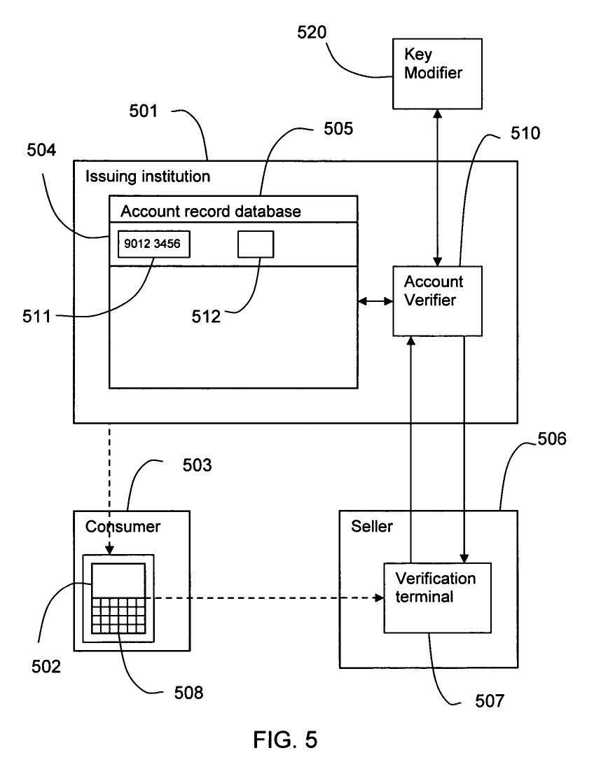

FIG. 5 shows another preferred embodiment of the present invention for a bank card verification process.

In this preferred embodiment, the verification process is similar to the process illustrated in FIG. 4.

An issuing institution 501 issues a bank card 502 and a verification key chart 508 to a consumer 503. The data structure of the bank card 502 and the verification key chart 508 is as illustrated in FIG. 3.

The issuing institution 501 keeps a consumer account record 504 in the account record database 505. A consumer account record 504 contains an account number 511 and a verification key descriptor 512. It may also contain other account data such as an expiry date, a maximum limit amount, the current balance, the current status, the consumer name, the consumer address, previous transactions, and other reference data.

In this preferred embodiment, the verification key descriptor 512 contains an expected verification key.

To make a purchase, the consumer 503 selects the current verification key from the verification key chart 508, as illustrated in FIG. 3. The verification key is used as a card verification code.

The consumer 503 provides the seller 506 with the bank card data, including the selected card verification code.

The seller 506 transfers the bank card data through a verification terminal 507 to an account verifier 510 at the issuing institution 501 for verification. The seller 506 may also transfer the seller identification and the purchase amount together with the bank card data.

The account verifier 510 at the issuing institution 501 verifies the validity of received bank card data by searching the account record database 505 for a matched consumer account record 504 which matches the received bank card number. If a matched record is found, the account verifier 510 verifies the card verification code with the expected verification key in the verification key descriptor 512.

The account verifier 510 may also verify other account data for consistency and limitations. The issuing institution 501 then sends the verification results to the seller 506.

If the payment transaction is successfully validated, the account verifier 510 modifies verification key descriptor 512 with the next verification key value according to a pre-determined updating algorithm or updating procedure.

A potential updating algorithm is a pseudo-random-number generator. An issuing institution may assign a different starting seed value for each card account to provide a different list of verification key values.

An updating procedure may also involve an external key modifier 520. The key modifier 520 may be a device attached to the account verifier 510. It may also be a separate verification key maintenance system, even at a remote location. Especially when a verification center is different from the issuing institution, the key modifier 520 may be located at the issuing institution.

This preferred embodiment may also be used in a different way. Instead of containing an expected verification key, the verification key descriptor 512 may contain a set of verification key parameters. During the verification process, the account verifier 510 uses these verification key parameters to derive an expected verification key, according to a pre-determined deriving algorithm.

If the transaction is successfully validated, the account verifier 510 modifies the verification key parameters in the verification key descriptor 512 to prepare for the next transaction verification, according to a pre-determined updating algorithm or updating procedure.

To provide the flexibility for deferred transaction verification, the verification system also needs to perform forward and backward checking of verification keys. These forward and backward verification keys may be generated in real time during the verification process. Verification key descriptor 512 may also include key storage spaces to store verification keys generated in previous verification processes.

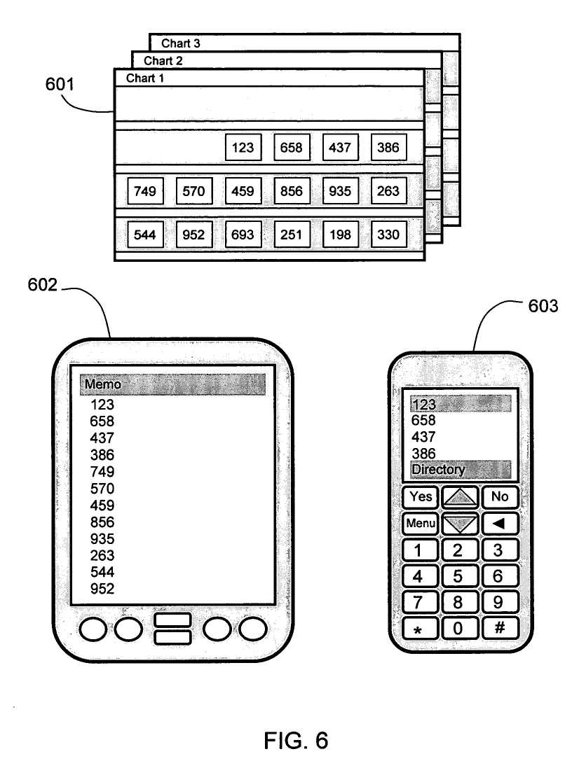

FIG. 6 shows a number of preferred embodiments of the present invention for a card holder to carry a list of verification keys.

Verification key label set 601 contains a set of verification key charts. The verification keys are printed on small detachable labels. After each successful purchase validation, the corresponding verification key label is physically detached from the key chart.

A card holder may use a personal digital assistant (PDA) device 602 to carry the list of verification keys. The list of verification keys are loaded into the PDA, either as directory entries, memo contents, or other data entries.

A card holder may enter the verification keys on the PDA, or load the verification keys through a communication channel.

After each successful purchase validation, the corresponding verification key item may be deleted from the list.

A card holder may also use a cellular telephone device 603 to carry the list of verification keys. The list of verification keys are loaded into the cellular telephone as directory entries. For a more complex cellular telephone, the verification keys may also be loaded as memo contents or other data entries.

A card holder may enter the verification keys on the cellular telephone, or load the verification keys through a communication channel.

After each successful purchase validation, the corresponding verification key item may be deleted from the list.

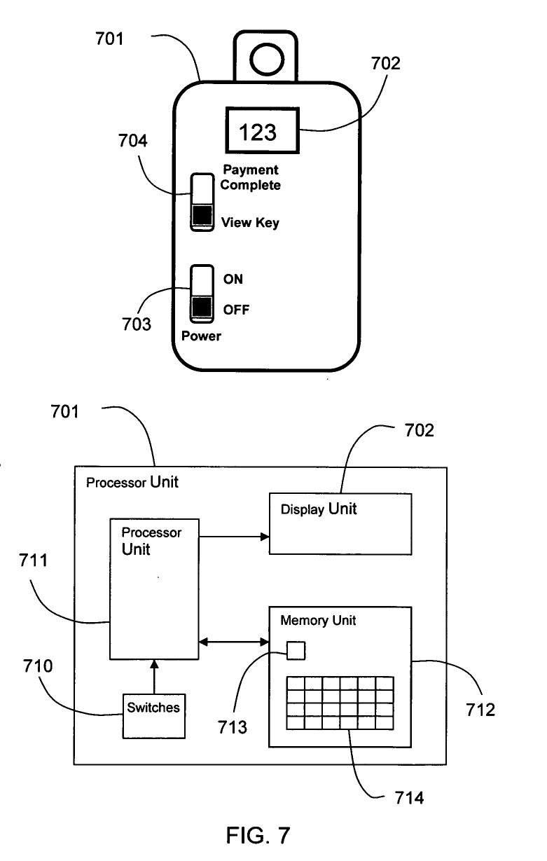

FIG. 7 shows a preferred embodiment of the present invention for a key storage device. The upper portion of FIG. 7 shows the external appearance. The lower portion of FIG. 7 shows a structure block diagram.

From the external appearance, the key storage device 701 appears as a key chain attachment.

From the internal structure, the key storage device 701 contains a display unit 702 and a number of switches 710. The key storage device 701 keeps a list of verification key values in a memory unit 712.

The memory unit 712 contains a verification key table 714 and a key index 713. The verification key table 714 contains a list of verification key entries. The key index 713 points to a current verification key entry in the verification key table 714.

A processor unit 711 controls the operation of the display unit 702, the switches 710, and the memory unit 712.

The Power switch 703 is a two-position switch which controls the power ON and OFF conditions. When the device power is turn on, the display unit 702 displays the current verification key entry, indexed by the key index 713. The card holder may give the current verification key entry value to the seller as a card verification code for a payment transaction.

The Payment Complete switch 704 is also a two-position switch, normally set to the View Key position. After each successful purchase validation, the card holder toggles the Payment Complete switch 704 to the Payment Complete position. Upon this action, the processor unit 711 updates key index 713 to point to the next verification key entry in the verification key table 714, as a new current verification key entry.

Once the current verification key value is updated, the card holder needs to toggle the Payment Complete switch 704 back to the View Key position to resume normal operation.

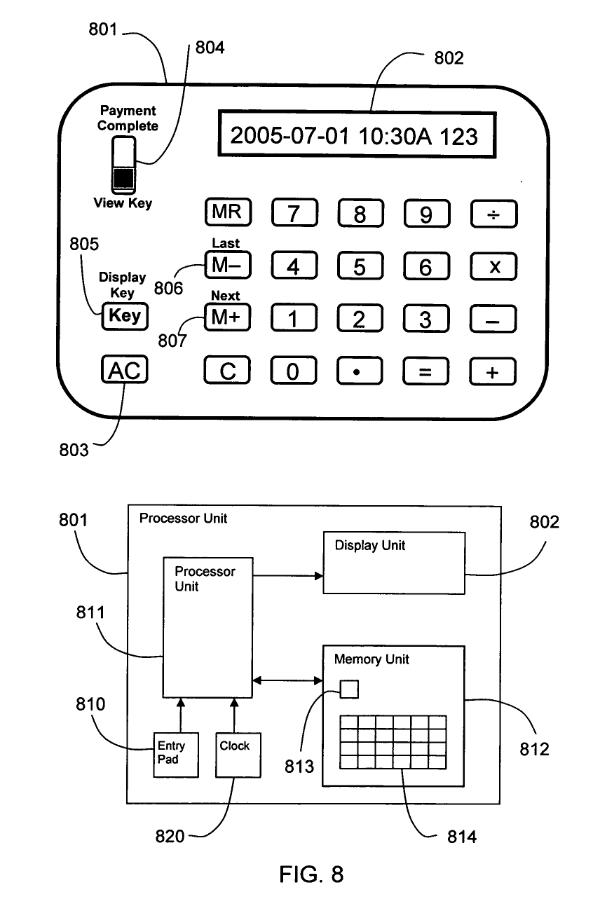

FIG. 8 shows another preferred embodiment of the present invention for a key storage device. The upper portion of FIG. 8 shows the external appearance. The lower portion of FIG. 8 shows a structure block diagram.

The key storage device 801 contains a display element 802 and an entry pad 810. The key storage device 801 keeps a list of verification key values in a memory unit 812.

The memory unit 812 contains a verification key table 814 and a key index 813. The verification key table 814 contains a list of verification key entries. The key index 813 points to a current verification key entry in the verification key table 814.

A processor unit 811 controls the operation of the display unit 802, the entry pad 810, and the memory unit 812.

The Power button 803 controls the power ON and OFF conditions. When the device power is turn on, the display unit 802 displays the current verification key entry, indexed by the key index 813.

The operation of the Payment Complete switch 804 is similar to the operation of Payment Complete switch 704 described in FIG. 7.

To provide more flexibility, the key storage device 801 includes more buttons. A Display Key button 805 instructs the device to display the current verification key entry value on the display unit 802. A Last button 806 instructs the device to display the last verification key entry value. A Next button 807 instructs the device to display the next verification key entry value.

In addition, the key storage device 801 includes a real-time clock unit 820. The real-time clock is used to keep a transaction history. At each payment completion, the processor unit 811 stores the transaction time in the memory unit 812.

Upon a Last button command, the display unit 802 displays the last transaction time along with the verification key entry value. The Last button 806 and the Next button 807 are used to scroll backward and forward through previous transactions. The Display Key button 805 resets the display back to the current verification key entry value.

Besides keeping track of the transaction history, this feature may assist the card holder to recover from a situation that the Payment Complete switch 804 was un-intentionally touched, which led to an incorrect updating of the current verification key value.

With a key verification system that allows deferred transaction processing, un-intentionally-skipped verification key may also be simply considered as a key that has been deferred, but never actually posted at a later time.

By adding a group of number buttons, the key storage device 801 may include a security protection feature. The key storage device 801 may require the purchaser to enter a password code in order to access the verification keys.

In addition, a consumer may enter a payment amount using the entry pad. The processor unit 811 may use the payment amount input and the current verification key entry to generate a final verification key, according to a pre-determined algorithm.

The final verification key may be viewed as a combined signature of the current verification key entry and the current payment amount.

The key storage device 801 shown in FIG. 8 may also include calculator functions, which complements the transaction processing operation.

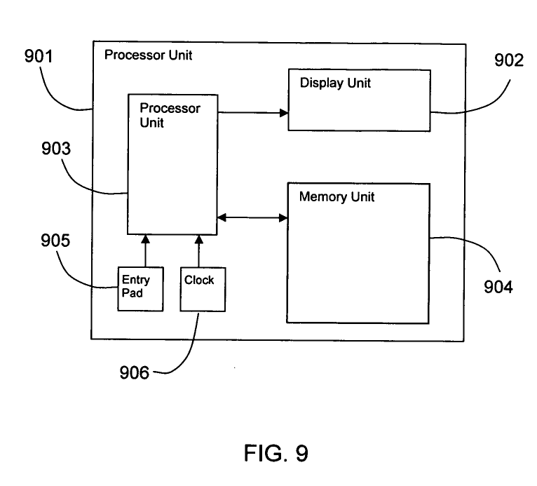

FIG. 9 shows a preferred embodiment of the present invention for a key maintenance device.

Instead of keeping a list of verification keys, the key maintenance device 901 uses a pre-determined updating algorithm to update the current verification key value, upon successful completion of a payment transaction.

A potential updating algorithm is a pseudo-random-number generator. The issuing institution may assign a different seed value for each card account to ensure that the key maintenance device 901 will go through a different list of verification keys.

In the key maintenance device 901, a processor unit 903 controls the operation of a display unit 902, a memory unit 904, an entry pad 905, and an optional real-time clock 906.

A key maintenance device 901 may also use a set of parameters and a pre-determined deriving algorithm to derive a current verification key value. Upon successful completion of a payment transaction, the processor unit 903 updates the set of parameters, such that the processor unit 903 will derive a different current verification key value for the next payment transaction.

In addition, a consumer may enter a payment amount using the entry pad 905. The processor unit 903 may use the payment amount input in a pre-determined deriving algorithm to derive the current verification key value.

The verification key may be viewed as a combined signature of the current key code and the current payment amount.

In this case, the payment amount will be sent, along with verification key, to the verification center for verification.

The present invention is applicable to either a card verification code (CVC) or a personal identification number (PIN). The CVC is also referred to, by different financial institutions, as a CVC2, CVV, CVV2, CVN, or CID. The term “verification code” or “verification key” are used to represent either a PIN or a version of the CVC numbers.

A bank card, depending on the payment terms, is referred to a credit card, a debit card, a check card, a cash card, an ATM card, or a similar name.

The verification of a payment transaction is also referred to as validation, authorization, approval, or a similar term.

The present invention is cost-effective to implement and highly compatible with the current account verification procedure.

I claim:

1. A credit card set comprising:
(a) a credit card identification means, containing a first credit card number;
(b) a verification key selection means, containing a first ordered list of three or more verification key entries, at least three of which are different in value;
wherein a credit card verification institution requires that a payment requester, when conducting a first payment transaction verification using a first type of verification procedure, to present:
(i) said first credit card number;
(ii) a first verification key entry, selected from said first ordered list, according to a first plurality of pre-determined key selection rules for consecutive occurrences of said first type of verification procedure;
wherein said credit card issuing institution requires that said payment requester, when conducting a second payment transaction verification using said first type of verification procedure, to present:
(i) said first credit card number;
(ii) a second verification key entry, selected from said first ordered list, according to said first plurality of pre-determined key selection rules, said second verification key entry is different from said first verification key entry in value;
wherein said credit card issuing institution requires that said payment requester, when conducting a third payment transaction verification using said first type of verification procedure, to present:
(i) said first credit card number;
(ii) a third verification key entry, selected from said first ordered list, according to said first plurality of pre-determined key selection rules, said third verification key entry is different from said first verification key entry and said second verification key entry in value.

2. The credit card set of claim 1, wherein said first plurality of pre-determined key selection rules specify that said payment requester selects said first verification key entry, said second verification key entry, and said third verification key entry, one by one, from said first ordered list, according to the order of the list.

3. The credit card set of claim 1, wherein said first plurality of pre-determined key selection rules specify that said payment requester, instead of selecting a first next verification key entry in said first ordered list, may skip forward within a first pre-determined number of verification key entries to select a first alternative verification key entry.

4. The credit card set of claim 1, wherein said first plurality of pre-determined key selection rules specify that said payment requester, instead of selecting a first next verification key entry in said first ordered list, may seek backward within a second pre-determined number of verification key entries to select a second alternative verification key entry, which is not previously used within a pre-determined time limit.

5. The credit card set of claim 1, wherein said verification key entries are card verification codes (CVC), also referred to by different financial institutions, as CVC2, CVV, CVV2, CVN, or CID.

6. The credit card set of claim 1, wherein said verification key entries are personal identification numbers (PIN).

7. The credit card set of claim 1, wherein said first ordered list is in a printing form, on papers or detachable labels.

8. The credit card set of claim 1, wherein said first ordered list is stored in an electronic device.

9. The credit card set of claim 1, wherein said credit card verification institution further requires said payment requester, when conducting said first payment transaction verification, said second payment transaction verification, or said third payment transaction verification, to present a first fixed-value personal identification code, in addition to said first verification key entry, said second verification key entry, or said third verification key entry.

10. The credit card set of claim 1, wherein said credit card verification institution also allows said payment requester to conduct a payment transaction verification using a second type of verification procedure, in which said payment requester is only required to present said first credit card number; said payment requester is not required to present a selected verification key entry from said first ordered list.

11. The credit card set of claim 1, wherein said credit card verification institution also allows said payment requester to conduct a payment transaction verification using a third type of verification procedure, in which said payment requester is required to present a second fixed-value personal identification code, instead of a selected verification key entry from said first ordered list.

12. A verification key maintenance device comprising:
(a) a processor unit;
(b) a memory unit, containing a verification key base value;
(c) a transaction information input means;
(d) a key output means;
(e) a key request signaling means;
(f) a completion signaling means;
wherein, said processor unit receives a transaction information entry from said transaction information input means;
wherein, said processor unit uses said verification key base value and said transaction information value to generate a verification key final value;
wherein, upon a key request signal from said key request signaling means, said processor unit sends said verification key final value to said key output means;
wherein upon a completion signal from said completion signaling means, said processor unit updates said verification key base value, according to a pre-determined updating algorithm.

13. The verification key maintenance device of claim 14, wherein said pre-determined updating algorithm is a random number generating algorithm.

14. The verification key maintenance device of claim 14, further comprises a power-up means and a password entry means wherein, upon a power-up signal from said power-up means, said processor unit must receive a password input from said password entry means before starting to accept said key request signal or said completion signal.

15. The verification key maintenance device of claim 14, further comprises a real-time clock means, wherein said processor unit stores the value of said real-time clock in said memory unit upon said completion signal.

16. An account data verification system comprising:
(a) a requester account data input means;
(b) a plurality of account records, each containing at least an explicit or partially implicit record account number and an expected verification key descriptor;
(c) a data verifier;
(d) a verification output means;
wherein said requester account data input means receives a first requester account data input, for a first type of verification procedure, said requester account data input includes at least a requester account number and a requester verification key;
wherein said account records are each uniquely distinguishable by said record account number;
wherein said data verifier generates a verification result, indicating whether or not there exists a successful validation condition such that said first requester account data input meets, at least, the requirements that:
(i) there exists a matched account record in said account records such that said record account number of said matched account record matches said requester account number;
(ii) if said matched account record exists, said requester verification key matches one of a first plurality of acceptable verification key entries, derived by said data verifier from a first key description, contained in said expected verification key descriptor of said matched account record, according to a first plurality of pre-determined acceptance rules;
wherein said data verifier sends said verification result to said verification output means;
wherein if said successful validation condition exists, said data verifier modifies said expected verification key descriptor of said matched account record, from said first key description to a second key description, such that:
(i) said data verifier will derive a second plurality of acceptable verification key entries from said second key description, according to said first plurality of pre-determined acceptance rules;
(ii) said second plurality of acceptable verification key entries are different from said first plurality of acceptable verification key entries by at least one key entry.

17. The account data verification system of claim 16, wherein said requester account data input means receives said requester account data input, directly or indirectly, from a point-of-sale device, an automated teller machine (ATM), a verification terminal at a financial institution, or a product or service provider which accepts payments via a telephone, a fax machine, an e-mail, or the Internet.

18. The account data verification system of claim 16,
wherein said expected verification key descriptor comprises:
(i) a key table, containing an ordered list of three or more verification key entries;
(ii) a table index, pointing to a current expected verification key entry in said key table;
wherein said first plurality of pre-determined acceptance rules specify that said first plurality of acceptable verification key entries include:
(i) a first pre-determined number of next verification key entries counting forward in said ordered list, starting from said current expected verification key entry;
(ii) a plurality of past verification key entries counting backward in said ordered list, starting from said current expected verification key entry; said past verification key entries are considered un-used according to a first plurality of pre-defined usage limitations.

19. The account data verification system of claim 16,
wherein said requester account data input further includes a requester payment transaction data;
wherein said expected verification key descriptor comprises:
(i) a key table, containing an ordered list of verification key entries;
(ii) a table index, pointing to a current expected verification key entry in said key table;
wherein said data verifier generates a first plurality of verification key base values, which include:
(i) a first pre-determined number of next verification key entries counting forward in said ordered list, starting from said current expected verification key entry;
(ii) a plurality of past verification key entries counting backward in said ordered list, starting from said current expected verification key entry; said past verification key entries are considered un-used according to a first plurality of pre-defined usage limitations;
wherein said first plurality of pre-determined acceptance rules specify that said first plurality of acceptable verification key entries are derived by performing a pre-defined mixing algorithm between said requester payment transaction data and each base value of said first plurality of verification key base values.

20. The account data verification system of claim 16,
wherein said expected verification key descriptor comprises a first expected verification key root value;
wherein said first plurality of pre-determined acceptance rules specify that said first plurality of acceptable verification key entries include:
(i) a first pre-determined number of next verification key entries derived from said first expected verification key root value, using a pre-determined forward deriving algorithm;
(ii) a plurality of past verification key entries, either derived from said first expected verification key root value, using a pre-determined backward deriving algorithm, under a first plurality of usage constraints, or stored in previous forward-deriving operations using said pre-determined forward deriving algorithm.

21. The account data verification system of claim 20, wherein said pre-determined forward deriving algorithm is a random number generator.

22. The account data verification system of claim 16,
wherein said expected verification key descriptor comprises a first expected verification key root value;
wherein said data verifier generates a first plurality of verification key base values, which include:
(i) a first pre-determined number of next key base values derived from said first expected verification key root value, using a pre-determined forward deriving algorithm;
(ii) a plurality of past key base values, either derived from said first expected verification key root value, using a pre-determined backward deriving algorithm, under a first plurality of usage constraints, or stored in previous forward-deriving operations using said pre-determined forward deriving algorithm.
wherein said first plurality of pre-determined acceptance rules specify that said first plurality of acceptable verification key entries are derived by performing a pre-defined mixing algorithm between said requester payment transaction data and each base value of said first plurality of verification key base values.
